(19) United States
(12) Patent Application Publication
(10) Pub. No.: US 2007/0094688 A1
(43) Pub. Date: Apr. 26, 2007

(54) Method system for event ticketing via a digital television channel.

(75) Inventor: Ty Briscoe, Venice, CA (US)

Correspondence Address: TY BRISCOE- THE TICKET CHANNEL, 1608 PACIFIC AVE #203, VENICE, CA, 90291, US

(73) Assignee: TANGITAL, INC., Venice, CA (US)

(21) Appl. No.: 10/906,300

(22) Filed: Feb. 14, 2005

Related U.S. Application Data
(60) Provisional application No. 60/521,064, filed on Feb. 13, 2004.

(51) Int. Cl. H04N 5/445; G06F 13/00; G06F 3/00

(52) U.S. Cl. 725/52; 725/53

(57) ABSTRACT

A network system whereby a digital event ticketing marketplace is created via a television channel hidden or designated for viewer-consumers to search event information and purchase tickets based on preset queries and for event content providers#promoters artist & venue owners to remotely post event market information with associated audio-visual content such as commercials music videos audio clips ring tones and animation to be displayed and accessed by viewer-users.

### DESCRIPTION

As the television and computer continue to slowly converge and become more integrated consumers will become more comfortable with making purchases from the television via their remote control. T-commerce.

Content owners such as artist-managers production companies venues event promoters and Internet ticketing networks associated with ticketed events provide content by setting up accounts with the digital ticketing channel remotely through a simple interface over the Internet. Account subscribers can manage multiple events through the digital ticketing channel where they can choose from a number of split screen display templates for each event. Templates provide numerous field arrangements for logo placement video display text and submittal forms. Providers upload and post event data through their accounts based on system query options with all necessary event related information and ticket pricing. Internet ticketing network agents set up parameters for transparent transaction automation through their existing Internet infrastructure. This information is then sent to the main server where it is stored and distributed to the digital channel distributor head-ends for the duration of the event performance-screening dates.

When channel is selected a welcome screen is sent to viewers television by way of a receiving station such as a set-top box or directly to a plug-and-play compatible viewing device. The digital ticketing channel welcome screen prompts a plurality of user-viewers to advance to start the ticket query process. Ticket query screen has a selectable menu that shows the preset query values relating to the specific market place of event ticketing. The ticketing query options include city date-range event category and artist screening or an independent artist-screening search can be retrieved.

Once query information is submitted it is sent to an application server at digital channel distributor head-end that contain software for processing. A queried request is matched and synchronized with real-time market information from database of content providers and ticketing networks through an Internet protocol connection. Request is then encoded compressed packaged and then returned to user-viewers receiving station to be displayed on their television screens.

At this and every point throughout screen navigation the user-viewer has the option to navigate back to previous screens.

Specific event listing screen is returned and displayed on viewers television. Content associated with event is presented at this point in the split screen format desired by the content provider. Viewer-customers can scroll to choose a specific event through remote control navigation while viewing content associated with the performance simultaneously purchasing tickets and optionally engaging in special promotions such as contest forms audio downloads ring tones etc. Once an event choice is made a specific event window with purchasing options appears in place of the event listings window. At this point viewers will then chose their ticket purchasing level and quantities.

If tickets are not on sale yet the viewer will have the opportunity to be notified of ticket availability through an onscreen alert email and or mobile device such as phone or PDA.

If no event information is available viewers will be prompted to return to initial query screen.

Once purchase options are received viewer will be given payment options consisting of payment method and ticket retrieval options. Purchasers will have the option to pay by credit card physical input or reader or have charge added to their monthly subscription bill if conditions permit. Ticket retrieval options include sending to wireless device such as phone or PDA e-mail for storage or later printing will call varying mail service levels and smart card.

Upon submittal customer will be given an information confirmation screen with option to return to make changes or proceed. Once changes are made and information is submitted customer will be lead to the purchase confirmation screen with receipt confirmation number to be printed saved or forwarded to an email account. Session ends with a thank you message and option to search for more tickets.

The business method satisfies when a consumer sees a movie trailer commercial of an event music video or hears a song they like of an artist while watching television to conveniently access the digital ticketing channel search artist-screenings time-dates and purchase tickets using the same remote control.

What is claimed is:

1. The method system claims a digital television channel search system whereby queried information is associated with multimedia content such as video images text animation and audio clips that is stored in a database to be matched with live market event & screening information with results then displayed on a viewer-users receiving device.

2. A method system comprised of a digital ticketing channel that performs transaction of upcoming-ticketed events & screenings via a television and remote control.

3. A database system that offers the means for content owners-providers that are associated with live events & screenings relating to ticket seating & reservation through purchasing to contribute information to a digital ticketing channel market place by managing multiple performance account dates in relation to ticket sales.

4. A system method that gives viewers the ability to be alerted of product-service availability by setting notification preferences via a digital channel in the form of an on-screen alert email and mobile device messaging phone or PDA through their television using a remote control.

5. A method of inserting programming based synchronized interactive impulse buy promotions such as purchase tickets now on any channel via a separate stream from the displayed programming giving responding viewers the option to immediately be sent to a digital ticketing channel hidden or designated for current ticket availability and transaction options.
